(19) United States
(12) Patent Application Publication
(10) Pub. No.: US 2020/0028413 A1
(43) Pub. Date: Jan. 23, 2020

(54) MOTOR DRIVE UNIT AND ELECTRIC POWER STEERING SYSTEM

(71) Applicant: NIDEC ELESYS CORPORATION, Kawasaki-shi, Kanagawa (JP)

(72) Inventors: Naoki YAMAMOTO, Kawasaki-shi (JP); Kazuki HARADA, Kawasaki-shi (JP)

(21) Appl. No.: 16/337,972

(22) PCT Filed: Sep. 29, 2017
(86) PCT No.: PCT/JP2017/035554

§ 371 Date: Mar. 29, 2019

(30) Foreign Application Priority Data
Sep. 30, 2016 (JP) 2016-192968

(51) Int. Cl. H02K 11/02; B62D 5/04; H02K 11/33; H02M 7/00; H02K 5/22

(52) U.S. Cl. CPC H02K 11/02; B62D 5/0406; B62D 5/046; H02M 2001/123; H02M 7/003; H02K 5/225; H02K 11/33

(57) ABSTRACT

A motor drive unit includes a case, a circuit board, a power connector, and a case connection portion connecting the circuit board and the case. The power connector includes a positive terminal and a negative terminal, and a positive line portion connected to the positive terminal and a substrate positive connection portion, and a negative line portion connected to the negative terminal and a substrate negative connection portion. A power circuit portion includes a common mode filter including first and second capacitors. A case connection portion includes an electrically conductive surrounding portion surrounding at least one of at least a portion of the positive line portion and at least a portion of the negative line portion, and a case connection line connected to a point between the first capacitor and the second capacitor, and an electrically conductive portion of the case.

### 1. TECHNICAL FIELD

The present disclosure relates to a motor drive unit including a common mode filter, and an electric power steering system or the like including a motor drive unit including a common mode filter.

### 2. BACKGROUND ART

A vehicle such as an automobile can include, as an onboard device, an electric power steering system, for example, and the electric power steering system generates an assist torque to assist the steering torque in a steering system that is generated by the operation of a steering handle by a driver. By the generation of the assist torque, the electric power steering system can reduce the burden on the driver. An assist torque mechanism to provide the assist torque detects a steering torque in the steering system with a steering torque detector, generates a drive signal with a controller based on the detection signal, and generates an assist torque corresponding to the steering torque with a motor based on the drive signal, whereby the assist torque is transmitted to the steering system by means of a speed reduction mechanism.

For example, Japanese Patent No. 5777797 discloses an electric power steering system including a motor drive unit, and a common mode filter of the motor drive unit is configured of a common mode coil and a combination of capacitors. However, the common mode coil upsizes the common mode filter. On the other hand, while a common mode filter that does not have a common mode coil can downsize the motor drive unit, common mode noise cannot be suppressed sufficiently.

### SUMMARY OF THE DISCLOSURE

Example embodiments of the present disclosure provide motor drive units that each suppress common mode noise.

In the following, aspect of example embodiments of according to the present disclosure will be explained for facilitating the understanding of the summary of the present disclosure.

In a first aspect, a motor drive unit includes a case, a circuit board, a power connector, and a case connection portion connecting the circuit board and the case. The power connector includes a positive terminal and a negative terminal, and includes a positive line portion connected to the positive terminal and a substrate positive connection portion of the circuit board, and a negative line portion connected to the negative terminal and a substrate negative connection portion of the circuit board. A power circuit portion of the circuit board includes a common mode filter, and the common mode filter includes a first capacitor connected to the substrate positive connection portion and a second capacitor connected in series with the first capacitor and connected to the substrate negative connection portion. The case connection portion includes an electrically conductive surrounding portion that surrounds at least any one of at least a portion of the positive line portion and at least a portion of the negative line portion, and a case connection line connected to a point between the first capacitor and the second capacitor, and the electrically conductive portion of the case. The case connection line and the surrounding portion are connected to each other.

In the first aspect, the electrically conductive surrounding portion is connected to the electrically conductive portion of the case by the case connection line. Additionally, in the first aspect, the surrounding portion surrounds at least any one of at least a portion of the positive line portion and at least a portion of the negative line portion. The inventors of example embodiments of the present disclosure have discovered that the motor drive unit including the common mode filter configured in this manner suppresses common mode noise. In addition, in the first aspect, since the common mode filter does not require a common mode coil, the first aspect downsizes the motor drive unit including such a common mode filter.

A person skilled in the art will easily understand that aspects of example embodiments according to the present disclosure can be further modified without departing from the spirit of the present disclosure.

The above and other elements, features, steps, characteristics and advantages of the present disclosure will become more apparent from the following detailed description of example embodiments with reference to the attached drawings.

### BRIEF DESCRIPTION OF THE DRAWINGS

FIG. 1 shows a schematic configuration example of an electric power steering system.

FIG. 2 shows an example of a circuit configuration diagram illustrating a motor drive unit.

FIGS. 3A and 3B show a schematic configuration example of a case connection portion.

FIGS. 4A and 4C show a connection example of three connection lines on the circuit board side and on the case side, FIG. 4B shows a layout example of the six portions of FIGS. 4A and 4C, FIG. 4D shows a layout example of a case connection line and a surrounding portion forming the case connection portion, and FIGS. 4E and 4F show a schematic configuration example of the case connection portion.

FIG. 5 shows an exemplary appearance of the motor drive unit.

FIGS. 6A and 6B show an exemplary appearance of two connection lines and the case connection portion, and FIG. 6C shows a layout example of the two connection lines and the case connection portion.

FIGS. 7A and 7B show an example of an explanatory view of the noise level on the positive line side of the motor drive unit that has the case connection portion of FIG. 6B, and that of a motor drive unit that does not have a case connection portion, respectively.

FIGS. 8A and 8B show an example of an explanatory view of the noise level on the negative line side of the motor drive unit that has the case connection portion of FIG. 6B, and that of a motor drive unit that does not have a case connection portion, respectively.

FIG. 9A shows another exemplary appearance of the motor drive unit, and FIG. 9B shows another layout example of the two connection lines and the case connection portion.

### DETAILED DESCRIPTION OF EXAMPLE EMBODIMENTS

Example embodiments described below are used for facilitating the understanding of the present disclosure. Accordingly, a person skilled in the art should note that the present disclosure is not wrongfully limited by the example embodiments described below.

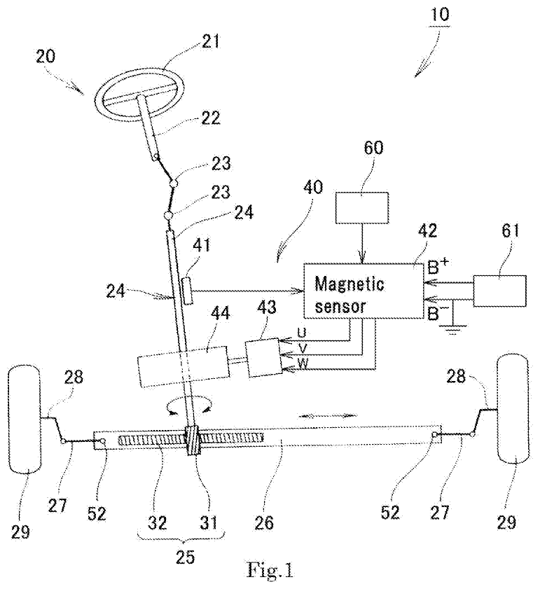

FIG. 1 shows a schematic configuration example of an electric power steering system. In the example of FIG. 1, an electric power steering system 10 includes an electronic control unit (in a broad sense, “a motor drive unit that drives a motor”) 42 for electric power steering. Specifically, the electric power steering system 10 includes an assist torque mechanism 40 that gives assist torque (also referred to as additional torque) to a steering system 20 extending from a steering handle (for example, a steering wheel) 21 for a vehicle to steered wheels (for example, front wheels) 29, 29 for the vehicle.

In the example of FIG. 1, the steering system 20 links a rotating shaft 24 (also referred to as a pinion shaft or an input shaft) with the steering handle 21 by means of a steering shaft 22 (also referred to as a steering column) and universal couplings 23, 23, links a rack shaft 26 with the rotating shaft 24 by means of a rack-and-pinion mechanism 25, and links the right and left steered wheels 29, 29 with both ends of the rack shaft 26 by means of right and left ball joints 52, 52, tie rods 27, 27, and knuckles 28, 28. The rack-and-pinion mechanism 25 includes a pinion 31 in the rotating shaft 24 and a rack 32 in the rack shaft 26.

According to the steering system 20, a driver steers the steering handle 21, and by that steering torque, can steer the steered wheels 29, 29 by means of the rack-and-pinion mechanism 25.

In the example of FIG. 1, the assist torque mechanism 40 is a mechanism that detects the steering torque of the steering system 20 given to the steering handle 21 with a steering torque detector (for example, a steering torque sensor) 41, generates a drive signal with the electronic control unit 42 (in a broad sense, a motor drive unit) based on the detection signal (also referred to as the torque signal), generates an assist torque (additional torque) corresponding to the steering torque with a motor 43 based on the drive signal, transmits the assist torque to the rotating shaft 24 by means of a speed reduction mechanism 44 (in a broad sense, a transmitter) such as a worm gear mechanism, and further, transmits the assist torque from the rotating shaft 24 to the rack-and-pinion mechanism 25 of the steering system 20.

The motor 43 (electric motor) is a brushless motor, for example, and the rotation angle of the rotor of the brushless motor or the rotation angle of the motor 43 (also referred to as the rotation signal) is detected by the electronic control unit 42.

The rotor is configured of a permanent magnet, for example, and the electronic control unit 42 can detect the motion of the permanent magnet (the N-pole and the S-pole), with a magnetic sensor. The motor 43 is typically a three-phase motor having motor supply terminals of three phases including U, V, and W.

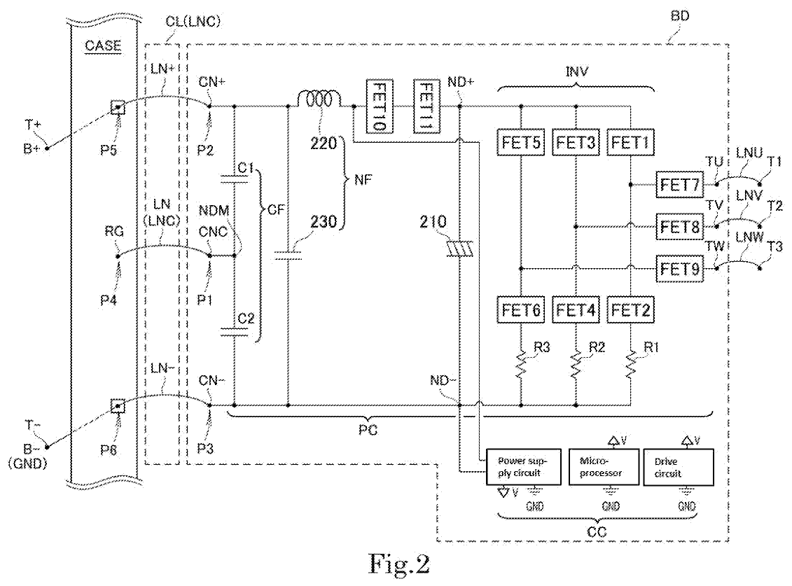

The electronic control unit 42, is configured of a power-supply circuit, a current sensor to detect a motor current (actual current), a microprocessor, an FET bridge circuit, and the magnetic sensor, for example. In addition to the torque signal, a vehicle speed signal, for example, can be input to the electronic control unit 42, as an external signal. An external device 60 is another electronic control unit that can communicate through an in-vehicle network such as a CAN (Controller Area Network), for example, and may be a vehicle speed sensor that can output a vehicle speed pulse corresponding to the vehicle speed signal, for example. Here, the external signal includes system-side signals such as the torque signal and vehicle body-side signals (vehicle body signals) such as the vehicle speed signal, and the vehicle body signal can include not only communication signals such as the vehicle-speed signal and engine speed but also an ON/OFF signal for an ignition switch. The microprocessor of the electronic control unit 42 can perform the vector control of the motor 43 based on the torque signal, the vehicle speed signal, and the like, for example. The FET bridge circuit to be controlled by the microprocessor is configured of an inverter circuit INV (see FIG. 2) to carry a drive current (three-phase alternating current) to the motor 43 (brushless motor), and specifically of an FET 1, an FET 2, an FET 3, an FET 4, an FET 5, and an FET 6 of FIG. 2, for example.

Such an electronic control unit 42 sets a target current based on at least the steering torque (torque signal), and preferably, sets the target current, also in consideration of the vehicle speed (vehicle speed signal, vehicle speed pulse) detected by the vehicle speed sensor and the rotation angle (rotation signal) of the rotor detected by the magnetic sensor. The electronic control unit 42 can control the drive current (drive signal) of the motor 43 such that the motor current (actual current) detected by the current sensor coincides with the target current.

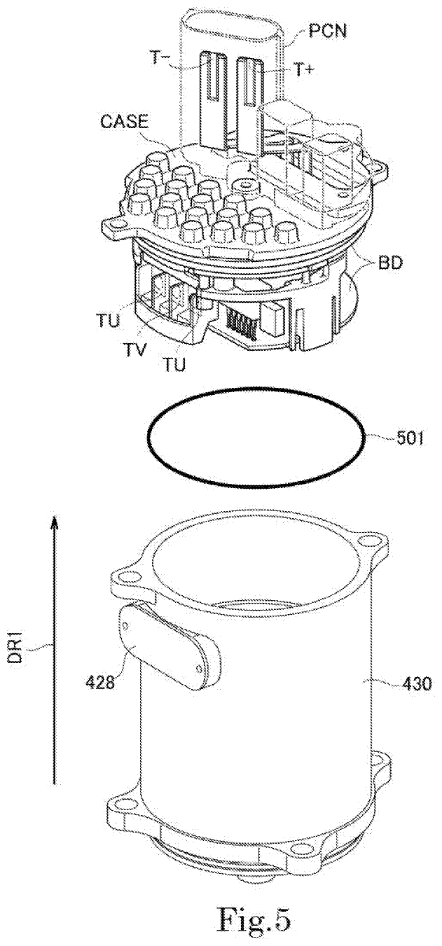

Reference character B+ denotes the electric potential of a positive electrode of a battery 61 that is provided in the vehicle as a direct-current power source, reference character B− denotes the electric potential of a negative electrode of the battery 61, and the electric potential B− of the negative electrode can be grounded on the vehicle body of the vehicle. Note that the electronic control unit 42 includes terminals (positive terminal T+ and negative terminal T−) that are parts connecting or coming into contact with battery 61-side terminals in a power connector PCN (see FIG. 5), which is an external connector, and the power supply voltage (the difference between the electric potential B+ of the positive electrode and the electric potential B− of the negative electrode) is a source of the drive signal of the motor 43.

FIG. 2 shows an example of a circuit configuration diagram illustrating a motor drive unit. While the electronic control unit 42 of FIG. 1 generates an assist torque based on the steering torque with the motor 43, the purpose of the motor drive unit of FIG. 2 is not limited to the electric power steering system of FIG. 1. That is, the motor drive unit of FIG. 2 may be any type as long as it can drive a three-phase motor such as the motor 43 of FIG. 1, and a microprocessor, for example, of FIG. 2 can control the drive current of the three-phase motor based on an arbitrary signal.

In the example of FIG. 2, the positive terminal T+ is an input terminal for inputting the electric potential B+ of the positive electrode of the battery 61 of FIG. 1, for example, the negative terminal T− is an input terminal for inputting the electric potential B− of the negative electrode of the battery 61, for example, and the motor drive unit 42 generates the drive signal of the motor 43 of FIG. 1 with the inverter circuit INV and has inverter output terminals TU, TV, and TW for outputting the drive signal, for example. Here, the drive signal is a three-phase power supply into which the power supply voltage (the difference between the electric potential B+ of the positive electrode and the electric potential B− of the negative electrode) is converted by the inverter circuit INV.

As shown in FIG. 2, the positive terminal T+ denotes the electric potential B+ of the positive electrode of the battery 61 of FIG. 1, for example, and the electric potential B+ is transmitted to a substrate positive connection portion CN+ by a positive line portion LN+ connected to the positive terminal T+ and the substrate positive connection portion CN+ of a circuit board BD. Similarly, the negative terminal T− denotes the electric potential B− of the negative electrode of the battery 61 of FIG. 1, for example, and the electric potential B− is transmitted to a substrate negative connection portion CN− by a negative line portion LN− connected to the negative terminal T− and the substrate negative connection portion CN− of the circuit board BD. When the negative terminal T− is grounded on the vehicle body of the vehicle, the electric potential B− is an electric potential GND of the vehicle body.

In the example of FIG. 2, the inverter circuit INV configured of the six FETs 1 to 6 is connected with an electrolytic capacitor 210 in parallel, with respect to a line of the electric potential B+ and a line of the electric potential B− (electric potential GND) from the substrate positive connection portion CN+ and the substrate negative connection portion CN− to the inverter circuit INV.

The FET 1 and the FET 2, which are connected in series between the line of the electric potential B+ and the line of the electric potential B−, can generate the U-phase current that flows through the U-winding, for example, of the motor 43. As a current sensor for detecting the U-phase current, a shunt resistor R1, for example, can be provided between the FET 2 and the line of the electric potential B−, and as a semiconductor relay capable of interrupting the U-phase current, an FET 7, for example, can be provided between a connection node of the FET 1 and FET 2 and the inverter output terminal TU.

The FET 3 and the FET 4, which are connected in series between the line of the electric potential B+ and the line of the electric potential B−, can generate the V-phase current that flows through the V-winding, for example, of the motor 43. As a current sensor for detecting the V-phase current, a shunt resistor R2, for example, can be provided between the FET 4 and the line of the electric potential B−, and as a semiconductor relay capable of interrupting the V-phase current, an FET 8, for example, can be provided between a connection node of the FET 3 and FET 4 and the inverter output terminal TV.

The FET 5 and the FET 6, which are connected in series between the line of the electric potential B+ and the line of the electric potential B−, can generate the W-phase current that flows through the W-winding, for example, of the motor 43. As a current sensor for detecting the W-phase current, a shunt resistor R3, for example, can be provided between the FET 6 and the line of the electric potential B−, and as a semiconductor relay capable of interrupting the W-phase current, an FET 9, for example, can be provided between a connection node of the FET 5 and FET 6 and the inverter output terminal TW.

The inverter output terminals TU, TV, and TW are respectively connected to three-phase motor supply terminals T1, T2, and T3 of the motor 43 by means of three-phase supply line portions LNU, LNV, and LNW.

In the example of FIG. 2, the six FETs 1 to 6 forming the inverter circuit can supply, as the drive signal or the three-phase power supply, U-phase current, V-phase current, and W-phase current to the motor 43, and the electrolytic capacitor 210 can smooth the power supply voltage (the difference between the electric potential B+ and the electric potential B−) that is a source of the drive signal. An FET 10 and an FET 11 as an example of a semiconductor relay capable of interrupting electric power are connected before a node ND+ of the line of the electric potential B+ to which the inverter circuit and the electrolytic capacitor are connected, and moreover, a coil 220 as an example of a normal mode filter NF is connected before the semiconductor relay. The normal mode filter NF can contain not only the coil 220, but also a capacitor 230 that is connected with the electrolytic capacitor 210 in parallel, with respect to the line of the electric potential B+ and the line of the electric potential B−. The normal mode filter NF can suppress the normal mode noise contained in the line of the electric potential B+.

In the example of FIG. 2, a first capacitor C1 and a second capacitor C2 as an example of a common mode filter CF are connected with the electrolytic capacitor 210 in parallel, before the line of the electric potential B+ and the line of the electric potential B− to which the normal mode filter NF is connected. Accordingly, the common mode filter CF is connected to the substrate positive connection portion CN+ and the substrate negative connection portion CN−. Specifically, one end of the first capacitor C1 is connected to the substrate positive connection portion CN+ by means of the line of the electric potential B+, one end of the second capacitor C2 is connected to the substrate negative connection portion CN− by means of the line of the electric potential B−, and the other end of the first capacitor C1 is connected to the other end of the second capacitor C2 by means of a connection node NDM. The second capacitor C2 is connected in series with the first capacitor C1, and the connection node NDM between the first capacitor C1 and the second capacitor C2 is connected with a substrate case connection portion CNC of the circuit board BD.

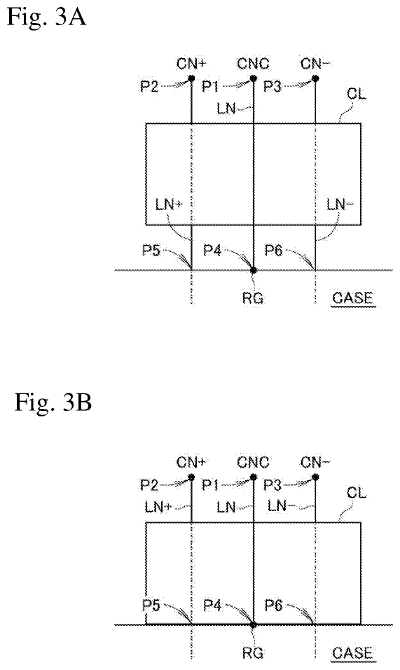

The electric potential between the first capacitor C1 and the second capacitor C2 is transmitted to an electrically conductive part RG of a case CASE, through a case connection line LN connected to the substrate case connection portion CNC. A case connection portion LNC connecting the circuit board BD and the case CASE not only has the case connection line LN, but also an electrically conductive surrounding portion CL (see FIGS. 3A and 3B) that surrounds at least one of at least a part of the positive line portion LN+ and at least a part of the negative line portion LN−. Since the case connection line LN and the surrounding portion CL are connected alternately, the electric potential between the first capacitor C1 and the second capacitor C2 is transmitted to the surrounding portion CL.

The inventors of the present disclosure have found that the motor drive unit including the common mode filter CF (first capacitor C1 and second capacitor C2) configured in the above manner suppresses common mode noise.

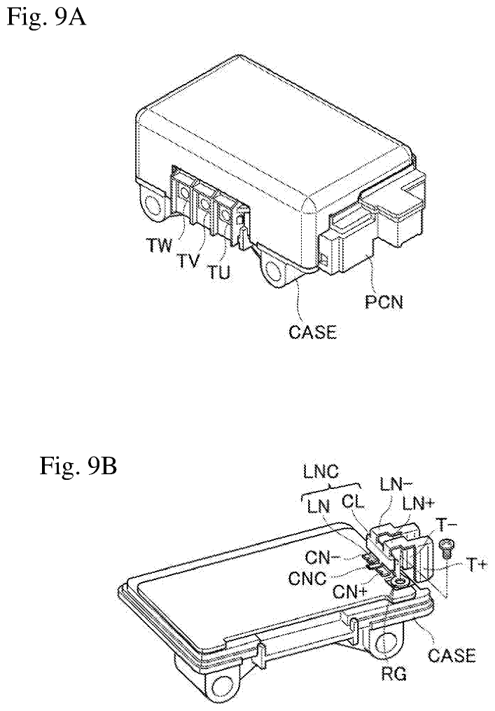

In the example of FIG. 2, the at least partially electrically conductive case CASE is disposed between the positive terminal T+ and the substrate positive connection portion CN+, and a through hole for allowing the positive line portion LN+ to pass through the case CASE is provided in the case CASE. Similarly, a through hole for allowing the negative line portion LN− to pass through the case CASE is provided in the case CASE. Note that when the case CASE is not disposed between the positive terminal T+ and the substrate positive connection portion CN+ (see FIG. 9B), provision of the through hole for the positive line portion LN+ in the case CASE is optional. Similarly, provision of the through hole for the negative line portion LN− in the case CASE is also optional.

In the example of FIG. 2, the electric potential of the electrically conductive part RG of the case CASE is different from the electric potential B− (electric potential GND), but it is preferable that the part RG also be grounded on the vehicle body of the vehicle. When the electric potential of the electrically conductive part RG of the case CASE is the electric potential B− (electric potential GND), the surrounding portion CL can suppress a larger amount of common mode noise.

In the example of FIG. 2, the circuit board BD has a power circuit portion PC and a control circuit portion CC, and the power circuit portion PC has the common mode filter CF connected to the substrate positive connection portion CN+ and the substrate negative connection portion CN−, the normal mode filter NF connected to the common mode filter CF, and the inverter circuit INV connected to the normal mode filter NF.

In the example of FIG. 2, the control circuit portion CC has a microprocessor that controls the inverter circuit INV with a drive circuit and sets a target current of the motor 43. As one example, the target current is set according to the torque signal, the motor current (actual current), the rotation signal acquired by means of the magnetic sensor, and the like. The control circuit portion CC has the drive circuit that generates six control signals (gate signals) corresponding to the FET 1 to FET 6 based on the target current, and the FET 1 to FET 6 are turned ON or OFF by the six control signals (gate signals), whereby the drive signal (drive current) is supplied to the motor 43.

In FIG. 2, an input circuit for inputting the torque signal, the motor current, and the like to the microprocessor, and the magnetic sensor for transmitting the rotation signal to the microprocessor are omitted.

If the circuit board BD has the semiconductor relays (FET 7 to FET 11), the microprocessor can control the semiconductor relays (FET 7 to FET 11). In this case, the microprocessor determines whether to turn ON or OFF each of the FET 7 to FET 11, and the drive circuit can generate five control signals (gate signals) corresponding to the FET 7 to FET 11 based on the determinations.

In the example of FIG. 2, the control circuit portion CC has a power supply circuit that generates the power supply for the microprocessor, the drive circuit, and the like, and the power supply circuit can generate the power supply voltage (the difference between an electric potential V and the electric potential GND) of the control circuit portion CC, by taking the power supply voltage (the difference between the electric potential B+ and the electric potential B− (electric potential GND)) of the power circuit portion PC with the connection node of the FET 10 and the coil 220, and a node ND−.

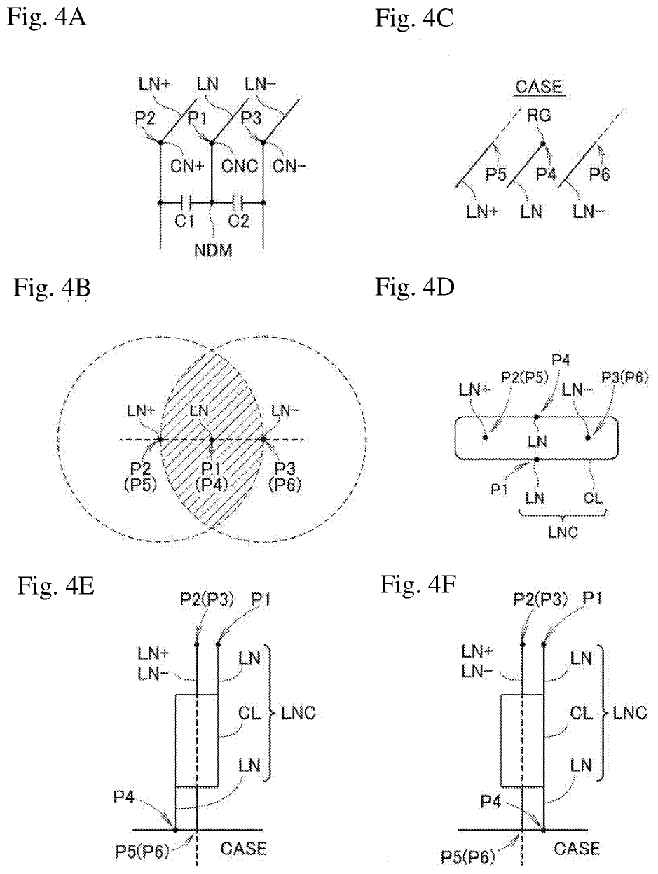

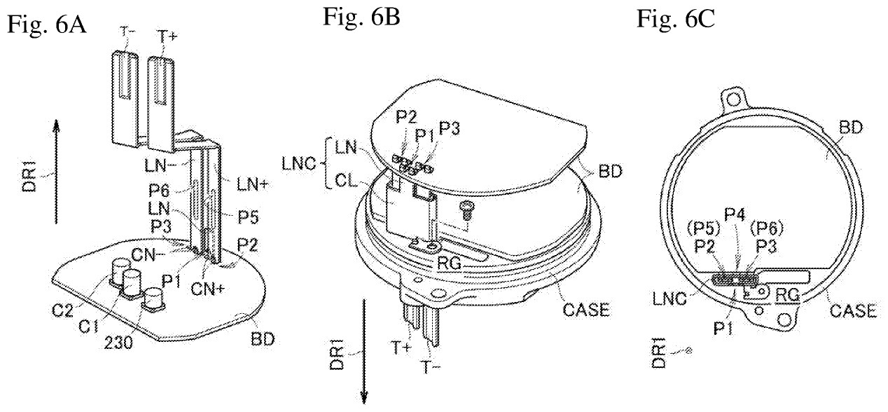

Each of FIGS. 3A and 3B shows a schematic configuration example (front view) of the case connection portion LNC. In the example of FIG. 3A, the surrounding portion CL of the case connection portion LNC surrounds both the positive line portion LN+ and the negative line portion LN−. The surrounding portion CL has a tubular portion (see FIG. 4D and FIG. 6B), and the positive line portion LN+ and the negative line portion LN− respectively connected to the substrate positive connection portion CN+ and the substrate negative connection portion CN− of the circuit board BD pass through the surrounding portion CL, and reach the positive terminal T+ and the negative terminal T− (see FIG. 2) by means of the through holes (see FIG. 2) in the case CASE.

In the example of FIG. 3A, the case connection line LN connected to the substrate case connection portion CNC of the circuit board BD reaches the electrically conductive part RG of the case CASE. A part of the case connection line LN comes into contact with the surrounding portion CL. Specifically, the case connection line LN and the surrounding portion CL are formed integrally (see FIG. 4D and FIG. 6B), and the entire metal case connection portion LNC is electrically conductive, for example.

In the example of FIG. 3A, a part (first part P1) of the case connection line LN connected with the substrate case connection portion CNC of the circuit board BD is one end, for example, of the case connection line LN. A part (second part P2) of the positive line portion LN+ connected with the substrate positive connection portion CN+ of the circuit board BD is one end, for example, of the positive line portion LN+. A part (third part P3) of the negative line portion LN− connected with the substrate negative connection portion CN− of the circuit board BD is one end, for example, of the negative line portion LN−. A part (fourth part P4) of the case connection line LN connected or coming into contact with the electrically conductive part RG of the case CASE is the other end, for example, of the case connection line LN. Parts (fifth part P5 and sixth part P6) of the positive line portion LN+ and the negative line portion LN− passing through the case CASE correspond to through holes (see FIG. 2) in the case CASE.

In the example of FIG. 3B, the surrounding portion CL extends to the case CASE, so that the case connection line LN and the surrounding portion CL come into contact with the case CASE. In other words, the surrounding portion CL of FIG. 3B surrounds or includes a larger part of the positive line portion LN+ and the negative line portion LN− than the surrounding portion CL of FIG. 3A. In other words, the surrounding portion CL preferably surrounds 70% or more of the outer periphery (lateral area) of the positive line portion LN+ and the negative line portion LN− between the case CASE and the circuit board BD, and the surrounding portion CL of FIG. 3A can suppress a larger amount of common mode noise.

FIG. 4A shows a connection example of the positive line portion LN+, the case connection line LN, and the negative line portion LN− on the circuit board BD side where the first capacitor C1 and the second capacitor C2 are disposed. The case connection line LN is connected to the substrate case connection portion CNC of the circuit board BD in the first part P1, the positive line portion LN+ is connected to the substrate positive connection portion CN+ in the second part P2, and the negative line portion LN− is connected to the substrate negative connection portion CN− in the third part P3.

FIG. 4B shows a layout example P1, P2, P3 of the three parts of FIG. 4A, where the first part P1 is the midpoint between the second part P2 and the third part P3. FIG. 4B shows an ideal layout example, and when the first part P1, the second part P2, and the third part P3 preferably satisfy the following relations (1) and (2), the case connection line LN can suppress a larger amount of common mode noise.

(1) A distance between the first part P1 and the second part P2 is equal to or smaller than a distance between the second part P2 and the third part P3, and (2) a distance between the first part P1 and the third part P3 is equal to or smaller than the distance between the second part P2 and the third part P3.

FIG. 4C shows a connection example of the positive line portion LN+, the case connection line LN, and the negative line portion LN− on the case CASE side. The case connection line LN is connected to the electrically conductive part RG of the case CASE in the fourth part P4, the positive line portion LN+ passes through the case CASE in the fifth part P5, and the negative line portion LN− passes through the case CASE in the sixth part P6.

FIG. 4B also shows a layout example (ideal layout example) of the three parts P4, P5, and P6 of FIG. 4C, where the fourth part P4 is the midpoint between the fifth part P5 and the sixth part P6. When the fourth part P4, the fifth part P5, and the sixth part P6 preferably satisfy the following relations (3) and (4), the case connection line LN can suppress a larger amount of common mode noise.

(3) A distance between the fourth part P4 and the fifth part P5 is equal to or smaller than a distance between the fifth part P5 and the sixth part P6, and (4) a distance between the fourth part P4 and the sixth part P6 is equal to or smaller than the distance between the fifth part P5 and the sixth part P6.

FIG. 4D shows a layout example (top view) of the case connection line LN and the surrounding portion CL that form the case connection portion LNC. In the example of FIG. 4D, although the first part P1 is not the midpoint between the second part P2 and the third part P3, and the fourth part P4 is not the midpoint between the fifth part P5 and the sixth part P6, the aforementioned relations (1) to (4) are satisfied, and therefore the case connection line LN of FIG. 4D can suppress a larger amount of common mode noise.

Each of FIGS. 4E and 4F shows a schematic configuration example (side view) of the case connection line LN and the surrounding portion CL that form the case connection portion LNC. For example, an entire metal case connection portion LNC is electrically conductive, the case connection line LN and the surrounding portion CL are formed integrally, and the first part P1 that is one end of the case connection line LN and the fourth part P4 that is the other end of the case connection line are electrically connected by the case connection line LN and the surrounding portion CL.

In the example of FIG. 4E, although the first part P1 that is one end of the case connection line LN and the fourth part P4 that is the other end of the case connection line LN are not disposed on a vertical line with respect to the case CASE, the aforementioned relations (1) to (4) can be satisfied.

In the example of FIG. 4E, even when the first part P1 that is one end of the case connection line LN and the fourth part P4 that is the other end of the case connection line LN are disposed on a vertical line with respect to the case CASE, the aforementioned relations (1) to (4) can be satisfied.

FIG. 5 shows an exemplary appearance of the motor drive unit. In the example of FIG. 5, the circuit board BD includes upper and lower or two substrates, and the multiple parts shown in FIG. 2 are implemented on the circuit board BD. The motor drive unit has the power connector PCN to which an external direct-current power source (battery 61) is connected by the positive terminal T+ and the negative terminal T−, and the circuit board BD is disposed inside the case CASE. The case CASE (first case) of FIG. 5 is, specifically, an upper lid or a lid body, and is used together with a case 430 (second case) that includes a housing portion of the circuit board BD and a housing portion of the motor 43. Note that direction DR1 points to the upper direction, for example, of the motor drive unit.

In the example of FIG. 5, a waterproofing member such as an O ring 501 can be fixed to the case CASE, and when the circuit board BD and the case CASE are stored inside the case 430, the O ring 501 can close the gap between the case CASE and the case 430 and make the motor drive unit waterproof.

In the example of FIG. 5, the case CASE has a heat dissipation or heat sinking property, and a lower face of the case CASE is brought into close contact with the inverter circuit INV implemented on the upper substrate, for example. An upper face of the case CASE has multiple protrusions (projections), and the protrusions increase the heat dissipation area when heat is dissipated to the upper face side of the case CASE, to prevent heat retention on the upper face of the case CASE.

Note that when the motor drive unit having the inverter output terminals TU, TV, and TW and the motor 43 having the three-phase motor supply terminals T1, T2, and T3 are stored in the case 430, the inverter output terminals TU, TV, and TW and the three-phase motor supply terminals T1, T2, and T3 are connected by connection portion such as screws serving as the three-phase supply line portions LNU, LNV, and LNW. Then, a lid 428 of the case 430 can cover the connection portion (exposed portion) of the inverter output terminals TU, TV, and TW and the three-phase motor supply terminals T1, T2, and T3.

FIG. 6A shows an exemplary appearance of the positive line portion LN+ and the negative line portion LN−. In the example of FIG. 6A, in order to supply the power supply voltage (the difference between the electric potential V and the electric potential GND) to the first capacitor C1, the second capacitor C2, the capacitor 230, and the like implemented on the circuit board BD (lower substrate), the positive line portion LN+ has a part extending downward from the positive terminal T+, a part parallel to the circuit board BD, and a part extending down to the substrate positive connection portion CN+ (second part P2). Similarly, the negative line portion LN− has a part extending downward from the negative terminal T−, a part parallel to the circuit board BD, and a part extending down to the substrate negative connection portion CN− (third part P3). In the example of FIG. 6A, the case connection line LN extending down to the first part P1 is disposed farther than the substrate positive connection portion CN+ and the negative line portion LN−. The first part P1, the second part P2, and the third part P3 satisfy the relations (1) and (2). Note that in the example of FIG. 6A, the upper substrate (circuit board BD) is omitted.

FIG. 6B shows an exemplary appearance of the case connection portion LNC. In the example of FIG. 6B, the case connection line LN and the surrounding portion CL are formed integrally, the entire case CASE is electrically conductive, and a lower face of the case CASE forms the electrically conductive part RG. The electric potential of the electrically conductive part RG is transmitted to the first part P1 through the contact part of the case CASE and the case connection portion LNC. In the example of FIG. 6B, the contact part (fourth part P4) of the case CASE and the case connection portion LNC is not shown. Additionally, the case connection portion LNC may have a fixing portion (for example, an internal thread member) for fixing to the case CASE (electrically conductive part RG), to fix the fixing portion and the case CASE (electrically conductive part RG) firmly with an external thread.

FIG. 6C shows a layout example (bottom view) of the positive line portion LN+, the negative line portion LN−, and the case connection portion LNC. In the example of FIG. 6C, the case connection portion LNC includes the positive line portion LN+ and the negative line portion LN−, while the lower substrate (circuit board BD) is omitted. Although the contact portion (fourth part P4) of the case CASE and the case connection portion LNC is not the midpoint between the fifth part P5 and the sixth part P6, the aforementioned relations (3) and (4) are satisfied.

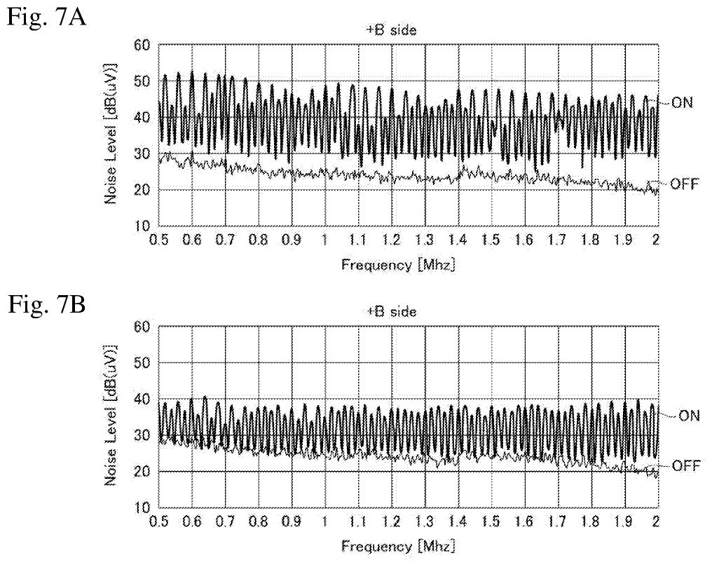

FIGS. 7A and 7B show an example of an explanatory view of the noise level on the positive line (the line of the electric potential B+) side of the motor drive unit that does not have the case connection portion LNC of FIG. 6B, and that of a motor drive unit that has the case connection portion LNC, respectively. In the example (comparative example) of FIG. 7A, the noise level when the motor 43 is turned ON is larger than the noise level (background noise level) when the motor 43 is turned OFF. However, in the example (Example) of FIG. 7B, the noise level (common mode noise) in the AM band, for example, when the motor 43 is turned ON is lowered. Note that when the electric potential of the electrically conductive part RG of the case CASE is the electric potential B− (electric potential GND), a larger amount of common mode noise can be suppressed on the side of the line of the electric potential B+.

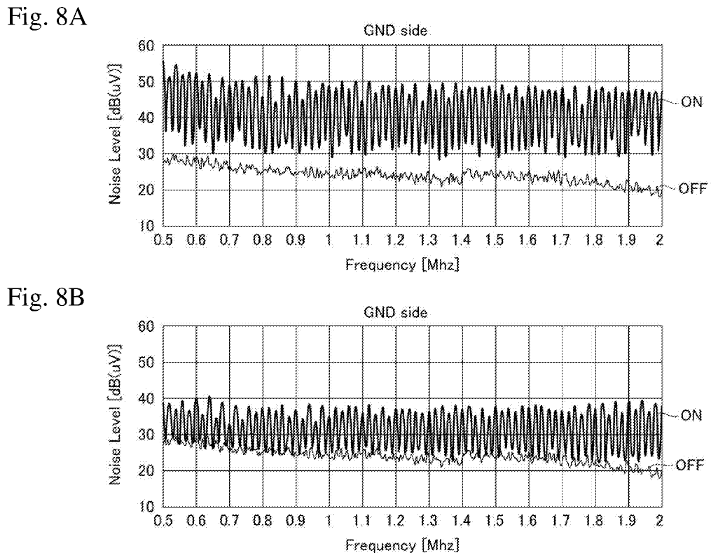

FIGS. 8A and 8B show an example of an explanatory view of the noise level on the negative line (the line of the electric potential B−) side of the motor drive unit that does not have the case connection portion LNC of FIG. 6B, and that of a motor drive unit that has the case connection portion LNC, respectively. In the example (comparative example) of FIG. 8A, the noise level when the motor 43 is turned ON is larger than the noise level (background noise level) when the motor 43 is turned OFF. However, in the example (Example) of FIG. 8B, the noise level (common mode noise) in the AM band, for example, when the motor 43 is turned ON is lowered. Note that when the electric potential of the electrically conductive part RG of the case CASE is the electric potential B− (electric potential GND), a larger amount of common mode noise can be suppressed on the side of the line of the electric potential B−.

FIG. 9A shows another exemplary appearance of the motor drive unit, and FIG. 9B shows another layout example of the positive line portion LN+, the negative line portion LN−, and the case connection portion LNC. In the example (motor drive unit) of FIG. 5, the circuit board BD is stored together with the motor 43 in the case CASE, 430. In the example (other motor drive unit) of FIG. 9A, the motor 43 is not stored in the case CASE, and the inverter output terminals TU, TV, and TW are exposed. The power connector PCN of FIG. 9A has the positive terminal T+ and the negative terminal T− of FIG. 9B.

In the example of FIG. 9B, the case CASE (lower lid or lid body) has a heat dissipation or heat sinking property, and the case CASE is brought into close contact with the inverter circuit INV. The entire case CASE is electrically conductive, and the case CASE can form the electrically conductive part RG. In the example of FIG. 9B, although the case CASE is not disposed between the positive terminal T+ and the substrate positive connection portion CN+, since the case connection portion LNC surrounding the positive line portion LN+ is connected to the substrate case connection portion CNC and the electrically conductive part RG of the case CASE, common mode noise can be suppressed. Similarly, although the case CASE is not disposed between the negative terminal T− and the substrate negative connection portion CN−, since the case connection portion LNC surrounding the negative line portion LN− is connected to the substrate case connection portion CNC and the electrically conductive part RG of the case CASE, common mode noise can be suppressed.

In the example of FIG. 9B, the case connection line LN and the surrounding portion CL are formed integrally, and the entire metal case connection portion LNC, for example, is electrically conductive. The case connection portion LNC has a fixing portion (for example, an internal thread member) for fixing to the case CASE (electrically conductive part RG).

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-5. (canceled)

6. A motor drive unit that drives a motor including a three-phase motor supply terminal, the motor drive unit comprising:
a case that is at least partially electrically conductive;
a circuit board disposed inside the case;
a power connector to which an external direct-current power source is connected; and
a case connection portion connecting the circuit board and the case; wherein
the power connector includes a positive terminal and a negative terminal, and includes a positive line portion connected to the positive terminal and a substrate positive connection portion of the circuit board, and a negative line portion connected to the negative terminal and a substrate negative connection portion of the circuit board;
the circuit board includes a power circuit portion and a control circuit portion;
the power circuit portion includes:
a common mode filter connected to the substrate positive connection portion and the substrate negative connection portion;
a normal mode filter connected to the common mode filter; and
an inverter circuit connected to the normal mode filter;
an inverter output terminal converted by the inverter circuit into a three-phase power supply to output the drive signal and the motor supply terminal are connected;
the common mode filter includes:
a first capacitor connected to the substrate positive connection portion; and
a second capacitor connected in series with the first capacitor and connected to the substrate negative connection portion;
the case connection portion includes:
an electrically conductive surrounding portion that surrounds at least any one of at least a portion of the positive line portion and at least a portion of the negative line portion; and
a case connection line connected to a point between the first capacitor and the second capacitor, and the electrically conductive surrounding portion of the case; and
the case connection line and the electrically conductive surrounding portion are connected to each other.

7. The motor drive unit according to claim 6, wherein the electrically conductive surrounding portion of the case connection portion surrounds about 70% or more of an outer periphery of the positive line portion and the negative line portion between the case and the circuit board.

8. The motor drive unit according to claim 6, wherein
the first capacitor and the second capacitor are disposed in the circuit board; and
of a first portion of the case connection line connected to the circuit board, a second portion of the positive line portion connected to the circuit board, and a third portion of the negative line portion connected to the circuit board, a distance between the first portion and the second portion is equal to or smaller than a distance between the second portion and the third portion, and a distance between the first portion and the third portion is equal to or smaller than the distance between the second portion and the third portion.

9. The motor drive unit according to claim 6, wherein
of a fourth portion of the case connection line connected to the electrically conductive portion of the case, a fifth portion of the positive line portion passing through the case, and a sixth portion of the negative line portion passing through the case, a distance between the fourth portion and the fifth portion is equal to or smaller than a distance between the fifth portion and the sixth portion, and a distance between the fourth portion and the sixth portion is equal to or smaller than the distance between the fifth portion and the sixth portion.

10. An electric power steering system comprising:
a steering torque detector that detects a steering torque of a steering system;
the motor drive unit according to claim 6;
a three-phase motor; and
a transmitter that transmits an assist torque to the steering system; wherein
the control circuit portion generates the assist torque based on the steering torque with the motor.
